(19) United States
(12) Patent Application Publication
(10) Pub. No.: US 2016/0177092 A1
(43) Pub. Date: Jun. 23, 2016

(54) OPTICAL FIBER COATING COMPOSITION WITH NON-REACTIVE REINFORCING AGENT

(71) Applicant: Corning Incorporated, Corning, NY (US)

(72) Inventors: Kevin Robert McCarthy, Horseheads, NY (US); David Neal Schissel, Painted Post, NY (US)

(21) Appl. No.: 14/957,095

(22) Filed: Dec. 2, 2015

Related U.S. Application Data
(60) Provisional application No. 62/093,465, filed on Dec. 18, 2014.

(51) Int. Cl. C08L 75/08; C08G 18/75

(52) U.S. Cl. CPC C08L 75/08; C08G 18/758

(57) ABSTRACT

A non-radiation curable reinforcing agent for optical fiber coatings and coating compositions. The reinforcing agent includes structurally flexible soft block segments and structurally rigid hard block segments. The soft block segments and hard block segments include urethane or urea linkages and act as strengthening additives in optical fiber coatings. Strength reinforcement occurs through interactions of the reinforcing agent with the polymeric network formed from curable components of the coating composition. Interactions include physical entanglements and hydrogen bonding. Soft block segments include block units that may include high molecular weight polyol linkages and soft block segments include block units that may include low molecular weight alkylene linkages. Coatings that include the reinforcing agents exhibit low Young's modulus, high tensile strength, and low glass transition temperatures and are suitable for use as primary coatings in optical fibers.

### FIELD

This application claims the benefit of priority under 35 U.S.C. §119 of U.S. Provisional Application Ser. No. 62/093,465 filed on Dec. 18, 2014 the content of which is relied upon and incorporated herein by reference in its entirety.

### FIELD

The present application relates to optical fiber coating compositions, components thereof, radiation-cured coatings formed from the compositions, coated optical fibers encapsulated by the cured coating, and methods of making the same.

### BACKGROUND

The light transmitting performance of an optical fiber is highly dependent upon the properties of the polymer coating that is applied to the fiber during manufacturing. Typically a dual-layer coating system is used where a soft inner-primary coating is in contact with the glass fiber and a harder, outer-primary or secondary coating surrounds the inner-primary coating. The hard coating allows the fiber to be handled and further processed, while the soft coating plays a key role in dissipating external forces and preventing them from being transferred to the fiber where they can cause microbend induced light attenuation.

The functional requirements of the inner-primary coating place various requirements on the materials that are used for these coatings. The Young's modulus of the inner-primary coating is generally less than 1 MPa, and is ideally less than 0.5 MPa. The glass transition temperature of the inner-primary coating is less than 5° C., and is ideally about −20° C. or less to ensure that the coating remains soft when the fiber is subjected to low temperatures. In order to ensure uniform deposition on the fiber, the coating is applied to the fiber in liquid form and must quickly form a solid having sufficient integrity to support application of the outer-primary coating. Also, the tensile strength of the coating, which generally decreases as the modulus decreases, must be high enough to prevent tearing defects during draw processing or subsequent processing of the coated fiber during cabling, etc.

To meet these requirements, optical fiber coatings have traditionally been formulated as mixtures of radiation curable urethane/acrylate oligomers and radiation curable acrylate functional diluents. Upon exposure to light and in the presence of a photoinitiator, the acrylate groups rapidly polymerize to form a crosslinked polymer network which is further strengthened by the hydrogen bonding interactions between urethane groups along the oligomer backbone. By varying the urethane/acrylate oligomer, it is possible to form coatings having very low modulus values while still having sufficient tensile strength. Numerous optical fiber coating formulations have already been disclosed in which the composition of the radiation curable urethane/acrylate oligomer has been varied to achieve different property targets.

Despite the ability to generate coatings that adequately protect the underlying optical fiber and produce low signal loss (attenuation), there continues to be a need to further improve the properties of optical fibers and their coatings. The present description is directed to overcoming these and other deficiencies in the art.

### SUMMARY

The description discloses exemplary embodiments of a non-radiation curable reinforcing agent for optical fiber coatings and coating compositions. The reinforcing agent includes structurally flexible soft block segments and structurally rigid hard block segments. The soft block segments and hard block segments include urethane or urea linkages and act as strengthening additives in optical fiber coatings. Strength reinforcement occurs through interactions of the reinforcing agent with the polymeric network formed from curable components of the coating composition. Interactions include physical entanglements and hydrogen bonding. Soft block segments include block units that may include high molecular weight polyol linkages and hard block segments include block units that may include low molecular weight alkylene linkages. Coatings that include the reinforcing agents exhibit low Young's modulus, high tensile strength, and low glass transition temperatures and are suitable for use as primary coatings in optical fibers.

A first aspect relates to:
A compound comprising;

a first block segment, said first block segment including a first block unit, said first block unit having the formula

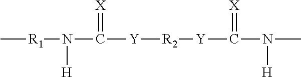

wherein X is O or S, Y is O or N(H), R1 comprises carbon, R2 comprises a polyether polyol group, a polyester polyol group, or a polycarbonate polyol group; and

a second block segment, said second block segment including a second block unit, said second block unit having the formula

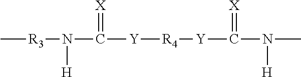

wherein X is O or S, Y is O or N(H), R3 comprises carbon and R4 is an alkylene group having 12 or fewer carbon atoms;

wherein said compound lacks a radiation-curable functional group and has a number average molecular weight of at least 5000 g/mol.

A second aspect relates to:
A coating composition comprising:

(I) a first radiation-curable component;

(II) a non-radiation-curable component, said non-radiation-curable component comprising a non-radiation-curable compound having:
a first block segment, said first block segment including a first block unit, said first block unit having the formula

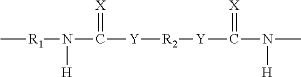

wherein X is O or S, Y is O or N(H); R1 comprises carbon; and R2 comprises a polyether polyol group, a polyester polyol group, or a polycarbonate polyol group; and
a second block segment, said second block segment including a second block unit, said second block unit having the formula

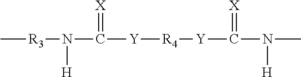

wherein X is O or S, Y is O or N(H), R3 comprises carbon and R4 is an alkylene group having 12 or fewer carbon atoms;
wherein said non-radiation-curable compound has a number average molecular weight of at least 5000 g/mol; and

(III) a photoinitiator.

A third aspect relates to:
A coated optical fiber comprising:

a glass fiber; and

a primary coating surrounding said glass fiber, said primary coating including the cured product of a radiation-curable composition comprising:
(I) a first radiation-curable component;
(II) a non-radiation-curable component, said non-radiation-curable component comprising a compound having:
   a first block segment, said first block segment including a first block unit, said first block unit having the formula

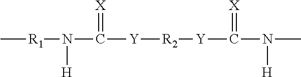

wherein X is O or S, Y is O or N(H), R1 comprises carbon, R2 comprises a polyether polyol group, a polyester polyol group, or a polycarbonate polyol group; and
   a second block segment, said second block segment including a second block unit, said second block unit having the formula

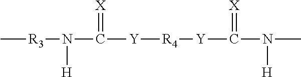

wherein X is O or S, Y is O or N(H), R3 comprises carbon and R4 is an alkylene group having 12 or fewer carbon atoms;
   wherein said compound has a molecular weight of at least 5000 g/mol;
and

(III) a photoinitiator.

A fourth aspect relates to:
A method comprising reacting a di(thio)isocyanate compound with a first diol compound to form a product, said product including a (thio)urethane linkage and lacking a radiation-curable group, said reacting occurring in the presence of a radiation-curable compound.

### BRIEF DESCRIPTION OF THE DRAWINGS

FIG. 1 is a schematic view of a coated optical fiber according one embodiment.

FIG. 2 is a schematic view of a representative optical fiber ribbon. The representative optical fiber ribbon includes twelve coated optical fibers.

### DETAILED DESCRIPTION OF THE EXEMPLARY EMBODIMENTS

The present description relates to curable optical fiber coating compositions, coatings formed from the curable coating compositions, and coated optical fibers encapsulated by the coating cured from the curable coating composition. The present description also relates to methods of making curable coating compositions, methods of making components of curable coating compositions, and methods of coating fibers with the curable coating composition. The coating composition includes a non-reactive reinforcing agent that strengthens coatings cured from the composition. The coatings may have low Young's modulus, high tensile strength and may be suitable as primary coatings for optical fibers.

In the description that follows, various components of coating compositions will be discussed and the amounts of particular components in the coating composition will be specified in terms of weight percent (wt %) or parts per hundred (pph). The components of the coating composition include base components and additives. The concentration of base components will be expressed in terms of wt % and the concentration of additives will be expressed in terms of pph.

As used herein, the weight percent of a particular base component refers to the amount of the component present in the coating composition on a basis that excludes additives. The additive-free coating composition includes only base components and may be referred to herein as a base composition or base coating composition. Any crosslinker component(s), diluent component(s), non-radiation-curable component(s), and polymerization initiator(s) present in a coating composition are regarded individually as base components and collectively as a base composition. The base composition minimally includes a radiation-curable component, a non-radiation-curable component, and a polymerization initiator. In the present description, the non-radiation-curable component is also referred to as a reinforcing agent. The radiation-curable component may be a radiation-curable crosslinker or a radiation-curable diluent. The base composition may, however, include one or more radiation-curable crosslinker components, one or more radiation-curable diluent components, one or more non-radiation-curable components, and one or more polymerization initiators. The collective amount of base components in a coating composition is regarded herein as equaling 100 weight percent.

Additives are optional and may include one or more of an adhesion promoter, an antioxidant, a catalyst, a carrier or surfactant, a tackifier, a stabilizer, and an optical brightener. Representative additives are described in more detail hereinbelow. The amount of additives introduced into the coating composition is expressed herein in parts per hundred (pph) relative to the base composition. For example, if 1 g of a particular additive is added to 100 g of base composition, the concentration of additive will be expressed herein as 1 pph.

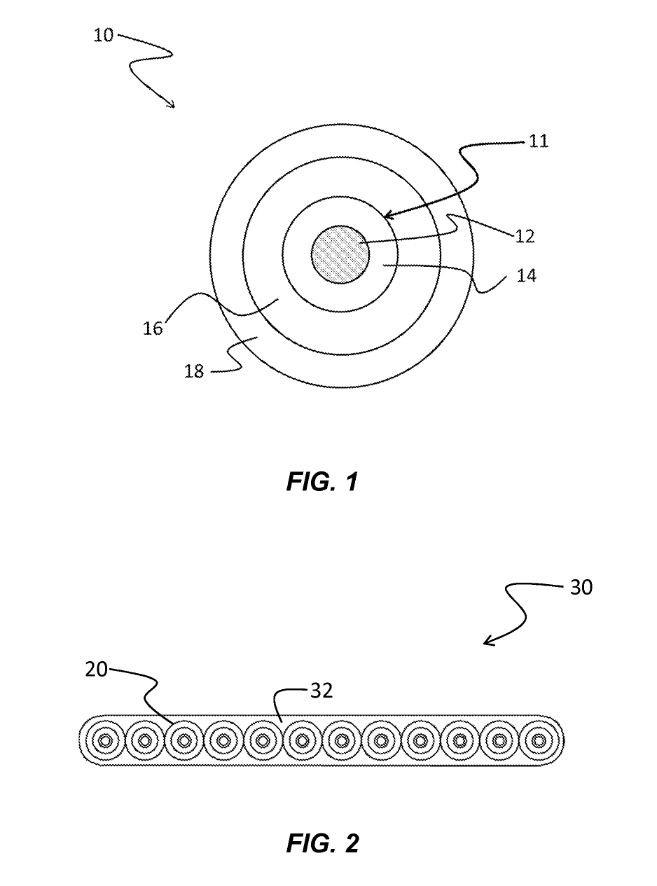

One embodiment relates to a coated optical fiber. An example of a coated optical fiber is shown in schematic cross-sectional view in FIG. 1. Coated optical fiber 10 includes a glass optical fiber 11 surrounded by primary coating 16 and secondary coating 18. The primary coating 16 is the cured product of a coating composition in accordance with the present description.

The glass fiber 11 is an uncoated optical fiber including a core 12 and a cladding 14, as is familiar to the skilled artisan. In many applications, the core and cladding layer have a discernible core-cladding boundary. Alternatively, the core and cladding layer can lack a distinct boundary. One such fiber is a step-index fiber. Exemplary step-index fibers are described in U.S. Pat. Nos. 4,300,930 and 4,402,570 to Chang, each of which is hereby incorporated by reference in its entirety. Another such fiber is a graded-index fiber, which has a core whose refractive index varies with distance from the fiber center. A graded-index fiber is formed basically by diffusing the glass core and cladding layer into one another. Exemplary graded-index fibers are described in U.S. Pat. No. 5,729,645 to Garito et al., U.S. Pat. No. 4,439,008 to Joormann et al., U.S. Pat. No. 4,176,911 to Marcatili et al., and U.S. Pat. No. 4,076,380 to DiMarcello et al., each of which is hereby incorporated by reference in its entirety.

The optical fiber may also be single or multi-moded at the wavelength of interest, e.g., 1310 or 1550 nm. The optical fiber may be adapted for use as a data transmission fiber (e.g. SMF-28®, LEAF®, and METROCOR®, each of which is available from Corning Incorporated of Corning, N.Y.). Alternatively, the optical fiber may perform an amplification, dispersion compensation, or polarization maintenance function. The skilled artisan will appreciate that the coatings described herein are suitable for use with virtually any optical fiber for which protection from the environment is desired.

The primary coating 16 desirably has a higher refractive index than the cladding of the optical fiber in order to allow it to strip errant optical signals away from the optical fiber core. The primary coating should maintain adequate adhesion to the glass fiber during thermal and hydrolytic aging, yet be strippable therefrom for splicing purposes. The primary coating typically has a thickness in the range of 25-40 μm (e.g. about 32.5 μm). Primary coatings are typically applied to the glass fiber as a liquid and cured, as will be described in more detail herein below.

The present primary coatings may be the cured product of a coating composition that includes a curable crosslinker, a curable diluent, a non-radiation-curable reinforcing agent, and a polymerization initiator. The coating composition may include one or more curable crosslinkers, one or more curable diluents, one or more non-radiation-curable reinforcing agents, and/or one or more polymerization initiators. In one embodiment, the curable crosslinker is essentially free of urethane and urea functional groups. In another embodiment, the non-radiation curable reinforcing agent includes (thio)urethane and/or (thio)urea groups.

As used herein, the term “curable” is intended to mean that the component, when exposed to a suitable source of curing energy, includes one or more curable functional groups capable of forming covalent bonds that participate in linking the component to itself or to other components to form the polymeric coating material (i.e., the cured product). The curing process may be induced by radiation or by thermal energy. A radiation-curable component is a component that can be induced to undergo a curing reaction when exposed to radiation of a suitable wavelength at a suitable intensity for a sufficient period of time. The radiation curing reaction may occur in the presence of a photoinitiator. A radiation-curable component may also optionally be thermally curable. Similarly, a thermally-curable component is a component that can be induced to undergo a curing reaction when exposed to thermal energy of sufficient intensity for a sufficient period of time. A thermally curable component may also optionally be radiation curable.

A curable component may include one or more curable functional groups. A curable component with only one curable functional group may be referred to herein as a monofunctional curable component. A curable component having two or more curable functional groups may be referred to herein as a multifunctional curable component or a polyfunctional curable component. Multifunctional curable components include two or more functional groups capable of forming covalent bonds during the curing process and can introduce crosslinks into the polymeric network formed during the curing process. Multifunctional curable components may also be referred to herein as “crosslinkers” or “curable crosslinkers”. Examples of functional groups that participate in covalent bond formation during the curing process are identified hereinafter.

As used herein, the terms “non-reactive”, “non-curable” and “non-radiation curable” are intended to refer to a compound or component of a coating composition that lacks functional groups capable of forming covalent bonds when exposed to the source of curing energy (radiation, thermal) during the curing process.

In one embodiment, the curable crosslinker is a radiation curable component of the primary coating composition, and as such it includes one or more functional groups capable of participating in the covalent bonding or crosslinking of the crosslinker into the polymeric coating. Exemplary functional groups capable of participating in the crosslinking include α,β-unsaturated ester, amide, imide or vinyl ether groups.

In one embodiment, the curable crosslinker is essentially free of urethane or urea groups. The curable crosslinker may also be essentially free of thiourethane or thiourea groups. By “essentially free” it is preferable that less than 1 weight percent of the curable crosslinker component includes (thio)urethane or (thio)urea groups. In preferred embodiments, less than 0.5 weight percent of the total curable crosslinker component includes (thio)urethane or (thio)urea groups. In most preferred embodiments, the curable crosslinker component is entirely free of both (thio)urethane and (thio)urea groups.

When identifying certain groups, such as urethane and thiourethane groups, or urea and thiourea groups, or isocyanate or thioisocyanate groups, these groups may be generically identified herein as (thio)urethane, (thio)urea, or (thio)isocyanate or di(thio)isocyanate to indicate that the sulfur atom(s) may or may not be present in the group. The group “(thio)urethane” means urethane or thiourethane. The group “(thio)urea” means urea or thiourea. The group “(thio)isocyanate” means isocyanate or thioisocyanate. Such groups may be referred to herein as (thio)groups and components containing (thio)groups may be referred to herein as (thio)components. The present embodiments extend to coating compositions that include (thio)components with sulfur atom(s) or without sulfur atom(s) in the (thio)functional group as well as compositions that include some (thio)components with sulfur atom(s) and some (thio)components without sulfur atom(s).

In certain embodiments, the curable crosslinker component includes one or more polyols that contain two or more α,β-unsaturated ester, amide, imide, or vinyl ether groups, or combinations thereof. Exemplary classes of these polyol crosslinkers include, without limitation, polyol acrylates, polyol methacrylates, polyol maleates, polyol fumarates, polyol acrylamides, polyol maleimides or polyol vinyl ethers comprising more than one acrylate, methacrylate, maleate, fumarate, acrylamide, maleimide or vinyl ether group. The polyol moiety of the curable crosslinker can be a polyether polyol, a polyester polyol, a polycarbonate polyol, or a hydrocarbon polyol.

The curable crosslinker component preferably has a molecular weight of between about 150 g/mol and about 15000 g/mol, in some embodiments more preferably between about 200 g/mol and about 9000 g/mol, in some embodiments preferably between about 1000 g/mol and about 5000 g/mol, in other embodiments preferably between about 200 g/mol and about 1000 g/mol. The curable crosslinker may further have a molecular weight in the range from 100 g/mol to 3000 g/mol, or in the range from 150 g/mol to 2500 g/mol, or in the range from 200 g/mol to 2000 g/mol, or in the range from 500 g/mol to 1500 g/mol.

The curable crosslinker component is present in the radiation curable composition in an amount of about 1 to about 20 percent by weight, or in an amount of about 2 to about 15 percent by weight, or in an amount of about 3 to about 10 percent by weight.

The curable diluent is a generally lower molecular weight (i.e., about 120 to 600 g/mol) liquid monomer that is added to the formulation to control the viscosity to provide the fluidity needed to apply the coating composition with conventional liquid coating equipment. The curable diluent contains at least one functional group that allows the diluent, upon activation during curing, to link to the polymer formed during the curing process from the curable crosslinker and other curable components. Functional groups that may be present in the curable diluent include, without limitation, acrylate, methacrylate, maleate, fumarate, maleimide, vinyl ether, and acrylamide groups.

Monofunctional diluents will contain only a single reactive (curable) functional group, whereas polyfunctional diluents will contain two or more reactive (curable) functional groups. Whereas the former can link to the polymer network during curing, the latter can form crosslinks within the polymer network.

When it is desirable to utilize moisture-resistant components, the diluent component will be selected on the basis of its compatibility with the selected moisture-resistant crosslinker(s) or component(s). Not all such liquid monomers may be successfully blended and copolymerized with the moisture-resistant crosslinker(s) or component(s) because such crosslinker(s) or component(s) are highly non-polar. For satisfactory coating compatibility and moisture resistance, it is desirable to use a liquid acrylate monomer component comprising a predominantly saturated aliphatic mono- or di-acrylate monomer or alkoxy acrylate monomers.

Suitable polyfunctional ethylenically unsaturated monomer diluents include, without limitation, methylolpropane polyacrylates with and without alkoxylation such as ethoxylated trimethylolpropane triacrylate with the degree of ethoxylation being 3 or greater, preferably ranging from 3 to about 30 (e.g. Photomer 4149 available from IGM Resins, and SR499 available from Sartomer Company, Inc.), propoxylated trimethylolpropane triacrylate with the degree of propoxylation being 3 or greater, preferably ranging from 3 to 30 (e.g. Photomer 4072 available from IGM Resins; and SR492 and SR501 available from Sartomer Company, Inc.), and ditrimethylolpropane tetraacrylate (e.g. Photomer 4355 available from IGM Resins); alkoxylated glyceryl triacrylates such as propoxylated glyceryl triacrylate with the degree of propoxylation being 3 or greater (e.g. Photomer 4096 available from IGM Resins; and SR9020 available from Sartomer Company, Inc.); erythritol polyacrylates with and without alkoxylation, such as pentaerythritol tetraacrylate (e.g. SR295 available from Sartomer Company, Inc.), ethoxylated pentaerythritol tetraacrylate (e.g. SR494 available from Sartomer Company, Inc.), and dipentaerythritol pentaacrylate (e.g. Photomer 4399 available from IGM Resins; and SR399 available from Sartomer Company, Inc.); isocyanurate polyacrylates formed by reacting an appropriate functional isocyanurate with an acrylic acid or acryloyl chloride, such as tris-(2-hydroxyethyl)isocyanurate triacrylate (e.g. SR368 available from Sartomer Company, Inc.) and tris-(2-hydroxyethyl)isocyanurate diacrylate; alcohol polyacrylates with and without alkoxylation such as tricyclodecane dimethanol diacrylate (e.g. CD406 available from Sartomer Company, Inc.), alkoxylated hexanediol diacrylate (e.g. CD564 available from Sartomer Company, Inc.), tripropylene glycol diacrylate (e.g. SR306 available from Sartomer Company, Inc.) and ethoxylated polyethylene glycol diacrylate with a degree of ethoxylation being 2 or greater, preferably ranging from about 2 to 30; epoxy acrylates formed by adding acrylate to bisphenol A diglycidylether and the like (e.g. Photomer 3016 available from IGM Resins); and single and multi-ring cyclic aromatic or non-aromatic polyacrylates such as dicyclopentadiene diacrylate.

It may also be desirable to use certain amounts of monofunctional ethylenically unsaturated monomer diluents, which can be introduced to influence the degree to which the cured product absorbs water, adheres to other coating materials, or behaves under stress. Exemplary monofunctional ethylenically unsaturated monomer diluents include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate (e.g. SR440 available from Sartomer Company, Inc. and Ageflex FA8 available from CPS Chemical Co.), 2-ethylhexyl acrylate, nonyl acrylate, decyl acrylate, isodecyl acrylate (e.g. SR395 available from Sartomer Company, Inc.; and Ageflex FA10 available from CPS Chemical Co.), undecyl acrylate, dodecyl acrylate, tridecyl acrylate (e.g. SR489 available from Sartomer Company, Inc.), lauryl acrylate (e.g. SR335 available from Sartomer Company, Inc., Ageflex FA12 available from CPS Chemical Co. (Old Bridge, N.J.), and Photomer 4812 available from IGM Resins), octadecyl acrylate, and stearyl acrylate (e.g. SR257 available from Sartomer Company, Inc.); aminoalkyl acrylates such as dimethylaminoethyl acrylate, diethylaminoethyl acrylate, and 7-amino-3,7-dimethyloctyl acrylate; alkoxyalkyl acrylates such as butoxylethyl acrylate, phenoxyethyl acrylate (e.g. SR339 available from Sartomer Company, Inc., Ageflex PEA available from CPS Chemical Co., and Photomer 4035 available from IGM Resins), phenoxyglycidyl acrylate (e.g. CN131 available from Sartomer Company, Inc.), lauryloxyglycidyl acrylate (e.g. CN130 available from Sartomer Company, Inc.), and ethoxyethoxyethyl acrylate (e.g. SR256 available from Sartomer Company, Inc.); single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bornyl acrylate, isobornyl acrylate (e.g. SR423 and SR506 available from Sartomer Company, Inc., and Ageflex IBOA available from CPS Chemical Co.), tetrahydrofurfuryl acrylate (e.g. SR285 available from Sartomer Company, Inc.), caprolactone acrylate (e.g. SR495 available from Sartomer Company, Inc.; and Tone M100 available from Union Carbide Company, Danbury, Conn.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated(4) nonylphenol acrylate (e.g. Photomer 4003 available from IGM Resins; and SR504 available from Sartomer Company, Inc.) and propoxylatednonylphenol acrylate (e.g. Photomer 4960 available from IGM Resins); acrylamides such as diacetone acrylamide, isobutoxymethyl acrylamide, N,N′-dimethyl-aminopropyl acrylamide, N,N-dimethyl acrylamide, N,N-diethyl acrylamide, and t-octyl acrylamide; vinylic compounds such as N-vinylpyrrolidone and N-vinylcaprolactam (both available from International Specialty Products, Wayne, N.J.); and acid esters such as maleic acid ester and fumaric acid ester.

The curable monomer diluent can include a single diluent component, or combinations of two or more monomer diluent components. The curable monomer diluent(s) is(are collectively) typically present in the coating composition in amounts of about 10 to about 60 percent by weight, more preferably between about 20 to about 50 percent by weight, and most preferably between about 25 to about 45 percent by weight.

The reinforcing agent is a non-radiation-curable component that includes (thio)urethane and/or (thio)urea groups. Although the reinforcing agent lacks radiation-curable functional groups and does not covalently bond to the polymeric network formed from the curable components of the coating composition to form chemical crosslinks, the reinforcing agent strengthens the polymeric network through hydrogen bonding interactions and/or physical crosslinks. The hydrogen bonding interactions and/or physical crosslinks occur between the reinforcing agent and polymer chains formed by curing curable components of the coating composition. The reinforcing agent includes hydrogen bonding groups that participate in hydrogen bonding interactions with hydrogen bonding groups present in the cured components of the coating composition. In one embodiment, the reinforcing agent includes hydrogen donor groups and interacts with hydrogen acceptor groups of the polymeric network of the coating. Representative hydrogen donor groups include (thio)urethane and (thio)urea groups. Physical crosslinks correspond to physical entanglements of the reinforcing agent with the polymer network formed from the curable components of the composition. The reinforcing agent may physically surround or spatially overlap multiple polymer chains of the network, or multiple sections of a single network polymer chain, to strengthen the network by creating steric or other physical barriers to motion, slippage, or scission of network polymer chains.

The molecular structure of the reinforcing agent includes hard block segments and soft block segments. As used herein, segment refers to a molecular sequence within the molecular structure of the reinforcing agent that includes one or more block units. If a particular block unit occurs two or more times within a segment, it may be referred to herein as a repeat unit or a block unit. In the reinforcing agent, the hard block segments differ from the soft block segments in chemical identity of the block unit.

In descriptive terms, hard block segments are regions of relative structural rigidity in the molecular structure of the reinforcing agent and soft block segments are regions of relative structural flexibility in the molecular structure of the reinforcing agent. Structural rigidity may be viewed in terms of the glass transition temperature (T_{g}) of homopolymers or copolymers formed from the block unit(s) of the hard and soft block segments. As is known in the art, polymers at temperatures below the glass transition temperature are structurally rigid and mechanically hard. Polymers at temperatures above the glass transition temperature are structurally flexible and mechanically soft. From this perspective, homopolymers formed from a particular number of block units of hard block segments have a higher glass transition temperature than homopolymers formed from the same number of block units of soft block segments. In one embodiment, the number of block units in the homopolymers formed from the block units of soft block segments and hard block segments is at least 100 and the glass transition temperature of the homopolymer formed from block units of hard block segments is higher than the glass transition temperature of the homopolymer formed from block units of the soft block segment. In another embodiment, the number of block units in the homopolymers formed from the block units of soft block segments and hard block segments is at least 500 and the glass transition temperature of the homopolymer formed from block units of hard block segments is higher than the glass transition temperature of the homopolymer formed from block units of the soft block segment.

The structure of the reinforcing agent may be represented herein as:

(A)₁-(B)ₘ (I)

where A refers to a soft block segment, B refers to a hard block segment, the index n is the number of segments that are soft block segments, and the index m is the number of segments that are hard block segments. The indices n and m represent the molar proportions of soft and hard block segments, respectively, in the present reinforcing agents. The molar proportion of soft block segments corresponds to the ratio of the index n to the sum of the indices n and m. The molar proportion of hard block segments corresponds to the ratio of the index m to the sum of the indices n and m. A reinforcing agent, for example, with 200 soft block segments and 300 hard block segments has n=200, m=300, a molar proportion of soft block segments of 0.40, and a molar proportion of hard block segments of 0.60. In the present reinforcing agents, the molar proportion of hard block segments may be ≧0.35, ≧0.40, ≧0.45, or ≧0.50, or ≧0.55, or ≧0.60, or ≧0.65, or in the range from 0.35 to 0.75, or in the range from 0.40 to 0.70, or in the range from 0.45 to 0.65.

It is understood that the ends of the structure of the reinforcing agent may include capping groups to terminate the functionality of the block units and/or intervening groups between soft block segments and hard block segments.

Although representation (I) depicts a structure for a reinforcing agent having a continuous sequence of soft block segments linked to a continuous sequence of hard block segments with only one bond between a soft block segment and a hard block segment, it is understood that soft block segments and hard block segments can be intermixed and/or arranged in any order relative to each other. Random, alternating, and ordered arrangements of hard and soft block segments may be included in the reinforcing agent. For example, the molecular structure of the reinforcing agent may correspond to the following representation (II):

(A)ₙ₁-(B)ₘ₁(A)ₙ₂-(B)ₘ₂-(A)ₙ₃- (II)

where n1, n2, n3 etc. may be the same or different and n1+n2+n3+ . . . =n and where m1, m2, m3 etc. may be the same or different and m1+m2+ . . . =m.

By way of example only, suitable configurations of soft block segments and hard block segments include, without limitation and where CAP refers to an optional capping group intended to limit reactivity of terminal functional groups present on soft block segments or hard block segments: CAP-Soft-Soft-Hard-CAP, CAP-Soft-Hard-Soft-CAP, and CAP-Hard-Soft-Soft-CAP; CAP-Soft-Soft-Soft-Hard-CAP, CAP-Soft-Soft-Hard-Soft-CAP, CAP-Soft-Hard-Soft-Soft-CAP, CAP-Hard-Soft-Soft-Soft-CAP, CAP-Hard-Soft-Hard-Soft-CAP, CAP-Hard-Soft-Soft-Hard-CAP, CAP-Soft-Hard-Soft-Hard-CAP; CAP-Soft-Soft-Soft-Soft-Hard-CAP, CAP-Soft-Soft-Soft-Hard-Soft-CAP, CAP-Soft-Soft-Hard-Soft-Soft-CAP, CAP-Soft-Hard-Soft-Soft-Soft-CAP, CAP-Hard-Soft-Soft-Soft-Soft-CAP, CAP-Soft-Soft-Hard-Soft-Hard-CAP, CAP-Soft-Hard-Soft-Hard-Soft-CAP, CAP-Soft-Hard-Soft-Soft-Hard-CAP, CAP-Hard-Soft-Hard-Soft-Soft-CAP, CAP-Hard-Soft-Soft-Hard-Soft-CAP, and CAP-Hard-Soft-Soft-Soft-Hard-CAP; CAP-Soft-Soft-Soft-Soft-Soft-Hard-CAP, CAP-Soft-Soft-Soft-Soft-Hard-Soft-CAP, CAP-Soft-Soft-Soft-Hard-Soft-Soft-CAP, CAP-Soft-Soft-Hard-Soft-Soft-Soft-CAP, CAP-Soft-Hard-Soft-Soft-Soft-Soft-CAP, CAP-Hard-Soft-Soft-Soft-Soft-Soft-CAP, CAP-Hard-Soft-Soft-Soft-Soft-Hard-CAP, CAP-Hard-Soft-Soft-Soft-Hard-Soft-CAP, CAP-Hard-Soft-Soft-Hard-Soft-Soft-CAP, CAP-Hard-Soft-Hard-Soft-Soft-Soft-CAP, CAP-Soft-Hard-Soft-Soft-Soft-Hard-CAP, CAP-Soft-Hard-Soft-Soft-Hard-Soft-CAP, CAP-Soft-Hard-Soft-Hard-Soft-Soft-CAP, CAP-Soft-Soft-Hard-Soft-Soft-Hard-CAP, CAP-Soft-Soft-Hard-Soft-Hard-Soft-CAP, and CAP-Soft-Soft-Soft-Hard-Soft-Hard-CAP; etc

Similarly, it is understood that the block units of each of several hard or soft block segments may be the same or different from each other. For example, the molecular structure of the reinforcing agent may correspond to the following representation (III):

(A)ₙ₁-(B)ₘ₁-(A′)ₙ₂-(B′)ₘ₂-(A″)ₙ₃- (III)

where n1, n2, n3 etc. may be the same or different, n1+n2+n3+ . . . =n; m1, m2, m3 etc. may be the same or different; m1+m2+ . . . =m; A may or may not be the same as A′ and A′ may or may not be the same as A″ etc.; and B may or may not be the same as B′ etc. In one embodiment, none of the block units of soft block segments A, A′, A″, . . . is the same as any of the block units of hard block segments B, B′, . . . . The soft block segments A, A′, A″, . . . may differ from each other in chemical identity of block unit and/or number of block units. The hard block segments B, B′, . . . may differ from each other in chemical identity of block unit and/or number of block units. Although the embodiment depicted in representation (III) shows an alternating arrangement of soft block segments and hard block segments, the present disclosure extends to variations of representation (III) in which two or more hard block segments are consecutive or in which two or more soft block segments are consecutive or in which hard block segments and soft block segments are randomly arranged, arranged alternately, or otherwise arranged in a partially ordered manner.

To promote strengthening of cured products of coating compositions that include the present reinforcing agents, it is desirable to include hydrogen bonding groups in the molecular structure of the reinforcing agents. The hydrogen bonding groups may be hydrogen donor groups or hydrogen acceptor groups. The reinforcing agent may include hydrogen donor groups and hydrogen acceptor groups.

In one embodiment, the block unit(s) of the soft block segments includes (thio)urethane and/or (thio)urea groups. In another embodiment, the block unit(s) of the hard block segments include (thio)urethane and/or thio(urea) groups. In still another embodiment, the block unit(s) of the soft block segments include (thio)urethane and/or (thio)urea groups and the block unit(s) of the hard block segments include (thio)urethane and/or thio(urea) groups. (Thio)urethane groups include —N—H groups that can function as hydrogen donors as well as carbonyl groups that can function has hydrogen acceptors. (Thio)urea groups include —N—H groups that can function has hydrogen donors.

In one embodiment, block unit(s) of the soft block segments and/or hard block segments include urethane groups formed from a reaction of an alcohol compound and an isocyanate compound. The alcohol compound may be a multifunctional alcohol compound that includes two or more alcohol groups (diol, triol, etc.). The isocyanate compound may be a multifunctional isocyanate compound that includes two or more isocyanate groups. Thiourethane groups may be similarly formed from reactions of alcohol compounds and thioisocyanate compounds.

By way of example, a diisocyanate and a diol react to form a urethane group according to the following reaction (IV):

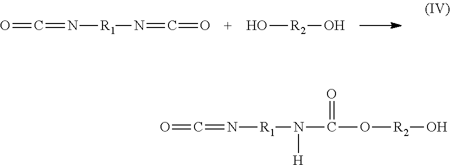

The terminal isocyanate and alcohol groups of the product may continue to react with further equivalents of the diisocyanate and diol reactants to produce a soft block segment or hard block segment having the formula (V):

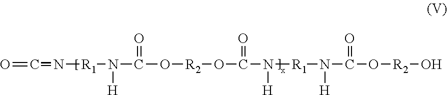

where the block unit is

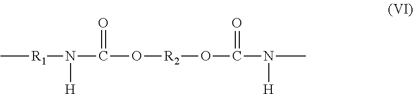

and x is the number of block units.

Although formula (V) depicts a segment having a terminal isocyanate group and a terminal alcohol group, it is recognized by those of skill in the art that the identity of the terminal groups depends on the relative stoichiometry of diisocyanate and diol reactants and that the segment may include two terminal isocyanate groups or two terminal alcohol groups. For example, in a preparation under conditions of excess diisocyanate reactant, the preponderance of segments will include two terminal isocyanate groups. It is further recognized that although the segment representation depicted in formula (V) includes two terminal functional groups, one or both terminal functional groups are converted when the segment is reacted with other segments having one or more terminal functional groups. For example, an alcohol terminal group is converted to a urethane linkage when reacted with a compound or segment containing an isocyanate group. Similarly, an isocyanate terminal group is converted to a urethane linkage when reacted with a compound or segment containing an alcohol group. Accordingly, although terminal functional groups are indicated in illustrative segment representation (V), when present as a segment in a reinforcing agent, the segment may have one or more terminal groups replaced by linkages (e.g. urethane or urea linkages) to other segments. Also, as noted hereinabove, terminal functional groups may be capped with a capping agent. Capping agents for terminal isocyanate groups include, for example, monofunctional alcohols and capping agents for terminal alcohol groups include, for example, monofunctional isocyanates.

The groups R₁ and R₂ are organic groups that link two or more functional groups of reactants that combine to form segments and may be referred to herein as linking groups. The linking groups may be linear or branched and may be aliphatic or aromatic. In one embodiment, the linking groups include one or more alkylene groups (e.g. methylene, ethylene, propylene, butylene etc.) or one or more substituted alkylene groups. In another embodiment, the linking groups include aromatic groups. In still another embodiment, the linking groups include one or more alkoxy groups (e.g. methoxy, ethoxy, propoxy, butoxy etc.) or one or more substituted alkoxy groups. In a further embodiment, the linking groups include one or more oxyalkylene groups (e.g. —OCH₂—, —OCH₂CH₂—, —OCH₂CH₂CH₂—, or generally —OR—, where R is a linear or branched alkylene group).

The linking groups may be the same or different in different reactants used to form a soft block segment or a hard block segment. The linking groups of reactants used to form soft block segments differ from linking groups used to form hard block segments. Linking groups favored for soft block segments are groups that are conducive to reducing the glass transition temperature when incorporated in a block unit of a homopolymer. Linking groups for soft block segments are relatively long molecular chains with weak hydrogen bonding interactions. Linking groups favored for hard block segments are groups that are conducive to increasing the glass transition temperature when incorporated in a block unit of a homopolymer. Linking groups for hard block segments are relatively short molecular chains with appreciable hydrogen bonding interactions. In one embodiment, the linking group of soft block segments includes oxyalkylene groups. The number of oxyalkylene groups in the linking group may be at least 5, or at least 10, or at least 20, or at least 50, or at least 100, or at least 150, or between 5 and 200, or between 10 and 100. A linking group containing two or more oxyalkylene groups may be referred to herein as a polyol group or a polyether polyol group. In one embodiment, a polyol linking group has the general form —(OR)_{z}—, where R′ is an alkylene group and z is the number of oxyalkylene groups. Other linking groups for soft block segments include polyester polyol groups, polycarbonate polyol groups, and hydrocarbon polyol groups. In another embodiment, the linking group of hard block segments includes alkylene groups.

As noted hereinabove, the terminal isocyanate and alcohol groups of segment (V) remain reactive and may continue to react. The reactivity of the terminal groups permits reactions segments of the type (V) with other segments of the type (V). Hard block segments, for example, can react with soft block segments to form reinforcing agents having at least one soft block segment and at least one hard block segment. Reinforcing agents of the types shown in representations (I), (II), and (III) above and variations thereof with any arrangement of hard block segments and soft block segments, for example, can be formed by reacting segments of the type shown in formula (V). The terminal groups of formula (V) may be capped with non-reactive functional groups to terminate the reaction or limit reactivity when desired.

In one embodiment, the reinforcing agent includes soft block segments having the form (V)

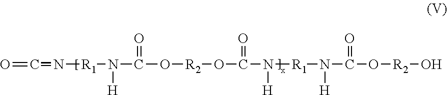

and hard block segments having the form (V′)

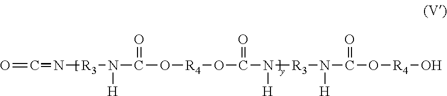

where the number of block units in the soft block segment is x and the number of block units in the hard block segment is y and where the links between soft block segments and hard block segments in the reinforcing agent has the following form (VII):

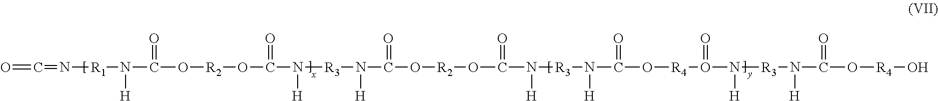

As noted hereinabove, the reinforcing agent may include multiple soft block segments and multiple hard block segments, where the multiple soft block segments and multiple hard block segments may be arranged in a random, ordered, alternating, or arbitrary manner, and where terminal groups may optionally be capped.

In one embodiment, R₁ differs from R₂ and R₃ differs from R₄. In another embodiment, R₁ differs from R₂ and R₄, but R₁ and R₃ are the same. In still another embodiment, the linking group R₂ has the form —R′—(OR′)_{z}—, where —(OR′)_{z}— is a polyol group as described hereinabove. In yet another embodiment, the linking group R₂ has the form —R′—(OR′)_{z}—, where —(OR′)_{z}— is a polyol group as described hereinabove and the linking group R₄ is an alkylene group, where the molecular weight of the linking group R₂ is greater than the molecular weight of the linking group R₄. In a further embodiment, the linking group R₂ has the form —R′—(OR′)ₓ—, where —(OR′)ₓ— is a polyol group as described hereinabove and the linking group R₄ is an alkylene group, where the molecular weight of the linking group R₂ is greater than the molecular weight of the linking group R₄, and the linking groups R₁ and R₃ are non-aromatic.

In one embodiment, the soft blocks are the reaction products of a di(thio)isocyanate and a polyol or amine-capped polyol, whereas the hard blocks are the reaction products of a di(thio)isocyanate and a diol or diamine comprising a hydrocarbon or oxygen-containing hydrocarbon having an average molecular weight of between about 28 g/mol to about 400 g/mol.

Reinforcing agents in accordance with the present disclosure may also be formed from reactions between amine groups and (thio)isocyanate groups to form (thio)urea groups. For example, a diisocyanate and a diamine react to form a urea linkage according to the following reaction (VIII):

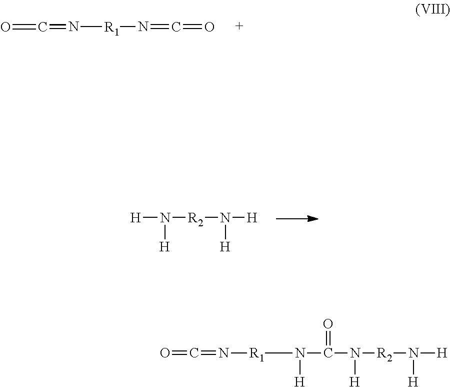

The terminal isocyanate and amine groups of the product may continue to react with further equivalents of the diisocyanate and diamine reactants to produce a soft block segment or hard block segment having the formula (IX):

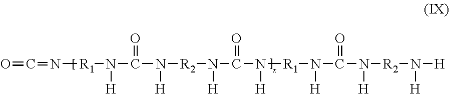

where the block unit is

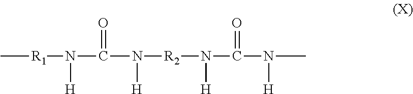

and x is the number of block units.

The terminal isocyanate and amine groups of segment (IX) remain reactive and may continue to react. The reactivity of the terminal groups permits reactions segments of the type (IX) with other segments of the type (IX) or with other segments of the type (V). Hard block segments, for example, can react with soft block segments to form reinforcing agents having at least one soft block segment and at least one hard block segment. Reinforcing agents of the types shown in representations (I), (II), and (III) above, for example, can be formed by reacting segments of the type shown in formula (IX) with each other or with segments of the type shown in formula (V). The terminal groups of formula (IX) may be capped with non-reactive functional groups to terminate the reaction or limit reactivity when desired. Linking groups for diisocyanates and diamines (or multifunctional isocyanates and multifunctional amines) are as described hereinabove for reactions between diisocyanates and diols (or multifunctional isocyanates and multifunctional alcohols). Terminal functional groups may also be optionally capped.

In one embodiment, the reinforcing agent includes soft block segments having the form (IX)

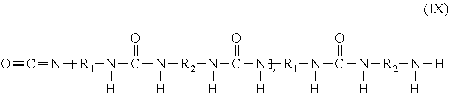

and hard block segments having the form (IX′)

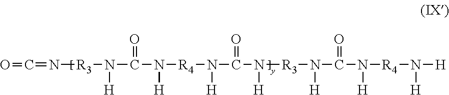

where the number of block units in the soft block segment is x and the number of block units in the hard block segment is y and where the links between soft block segments and hard block segments in the reinforcing agent has the following form (XI):

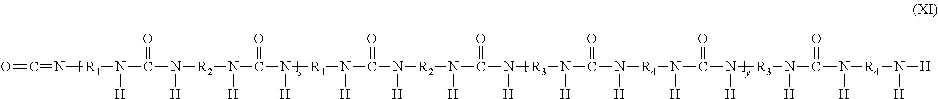

As noted hereinabove, the reinforcing agent may include multiple soft block segments and multiple hard block segments, where the multiple soft block segments and multiple hard block segments may be arranged in a random, ordered, alternating, or arbitrary manner.

In one embodiment, R₁ differs from R₂ and R₃ differs from R₄. In another embodiment, R₁ differs from R₂ and R₄, but R₁ and R₃ are the same. In still another embodiment, the linking group R₂ has the form —R′—(OR′)_{z}—, where —(OR′)_{z}— is a polyol group as described hereinabove. In yet another embodiment, the linking group R₂ has the form —R′—(OR′)_{z}—, where —(OR′)_{z}— is a polyol group as described hereinabove and the linking group R₄ is an alkylene group, where the molecular weight of the linking group R₂ is greater than the molecular weight of the linking group R₄. In a further embodiment, the linking group R₂ has the form —R′—(OR′)_{z}—, where —(OR′)_{z}— is a polyol group as described hereinabove and the linking group R₄ is an alkylene group, where the molecular weight of the linking group R₂ is greater than the molecular weight of the linking group R₄, and the linking groups R₁ and R₃ are non-aromatic.

The molecular weight of the present non-radiation-curable reinforcing agents is preferably sufficiently high to promote entanglement with the crosslinked acrylate network formed by the radiation curable crosslinking monomer(s) and diluent(s) of the coating composition, but also sufficiently low to facilitate solubility of the reinforcing agent in uncured, liquid coating formulations. Molecular weights described herein include number average molecular weight, weight average molecular weight, and are expressed with respect to polystyrene standards.

The number average molecular weight of the reinforcing agent is greater than 5000 g/mol, or greater than 7500 g/mol, or greater than 10000 g/mol, or greater than 12500 g/mol, or greater than 15000 g/mol, or greater than 17500 g/mol, or greater than 20000 g/mol, or between 5000 g/mol and 25000 g/mol, or between 5000 g/mol and 20000 g/mol, or between 5000 g/mol and 15000 g/mol, or between 10000 g/mol and 20000 g/mol, or between 1000 g/mol and 20000 g/mol, or between 2000 g/mol and 19000 g/mol, or between 3000 g/mol and 18000 g/mol.

The number average molecular weight of soft block segments in the reinforcing agent may be less than 10,000 g/mol, or less than 7500 g/mol, or less than 5000 g/mol, or less than 2500 g/mol, or less than 1000 g/mol, or less than 500 g/mol, or between 200 g/mol and 10,000 g/mol, or between 400 g/mol and 7500 g/mol, or between 600 g/mol and 5000 g/mol, or between 800 g/mol and 4000 g/mol, or between 1000 g/mol and 3000 g/mol. The number average molecular weight of hard block segments in the reinforcing agent may be less than 10,000 g/mol, or less than 7500 g/mol, or less than 5000 g/mol, or less than 2500 g/mol, or less than 1000 g/mol, or less than 500 g/mol, or between 200 g/mol and 10,000 g/mol, or between 400 g/mol and 7500 g/mol, or between 600 g/mol and 5000 g/mol, or between 800 g/mol and 4000 g/mol, or between 1000 g/mol and 3000 g/mol.

The degree of intramolecular (self association) vs. intermolecular (association with the cured network) interaction of the reinforcing agent in the cured coating (through hydrogen bonding) depends on the molar ratio of hard block segments and soft block segments in the reinforcing agent. The relative balance of intramolecular and intermolecular interactions influences the tensile properties of cured coatings. The relative balance of intramolecular and intermolecular interactions can be adjusted through the molar proportions of hard block segments and soft block segments as described above, and also by varying the molecular weight of polyol used in the soft block segment when the molar proportions of hard block segments and soft block segments is constant. One skilled in the art will exercise care when designing the oligomer. While a higher proportion of hard block segments relative to soft block segments is expected to result in increased cured coating integrity and performance through increased intermolecular hydrogen bonding interactions between the reinforcing agent and the cured coating, a higher proportion of hard block segments relative to soft block segments may also promote strong intramolecular hydrogen bonding interactions that may limit the solubility of the reinforcing agent in a coating formulation or lead to physical gelation of the reinforcing agent during synthesis or after incorporation into a curable coating formulation before radiation curing has taken place.

The degree of intramolecular and intermolecular interactions through hydrogen bonding can be also adjusted by varying the molecular weight of the polyol or amine-capped polyol used as a linking group in soft block segment(s) of the reinforcing agent. For example, one could use a single soft block segment with a molecular weight of about 8000 g/mol or multiple soft block segments having a lower molecular weight, but collectively having about the same overall molecular weight. Use of multiple soft block segments provides more urethane/urea linkages to the reinforcing agent and would be expected to hydrogen bond more strongly to the cured network portion of the coating. The number of urethane/urea linkages and the numbers of soft block segments and hard block segments can be adjusted in the synthesis of the reinforcing agents.

Representative diisocyanate compounds that are suitable as reactants for forming soft block and hard block segments in the present reinforcing agents are shown in Table 1 below. The list of compounds presented in Table 1 is intended to be representative, but not limiting, of the linking groups that may be used in diisocyanate (or multifunctional isocyanate) compounds. In the depictions of Table 1, the squiggly lines show the positions of the isocyanate groups in diisocyanate embodiments. In toluene diisocyanate (TDI), the methyl group defines the 1-position of the aromatic ring, one isocyanate group is fixed at the 2-position of the aromatic ring, and the second isocyanate group may be positioned at any of the 3-, 4-, 5- or 6-positions. In the case of alkyl diisocyanates, isocyanate groups are positioned at the two terminal positions of the alkylene linking group. The corresponding dithioisocyanate or multifunctional thioisocyanate compounds may also be used.

TABLE I
Isocyanate Compounds and Linking Groups

| Isocyanate Compound | Linking Group |
|---|---|
| 4,4′-methylene bis(cyclohexyl) diisocyanate (H12MDI) | 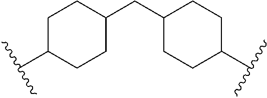 [SMILES: *C1CCC(CC2CCC(*)CC2)CC1] |
| toluene diisocyanate (TDI) | 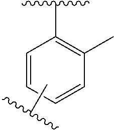 |
| Isophorone diisocyanate (IPDI) | 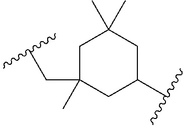 [SMILES: *CC1(C)CC(*)CC(C)(C)C1] |
| Tetramethyl-1,3-xylylene diisocyanate (XDI) | 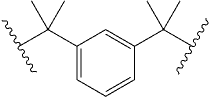 [SMILES: *C(C)(C)c1cccc(C(*)(C)C)c1] |
| 4,4′-methylene bis(phenyl) diisocyanate (MDI) | 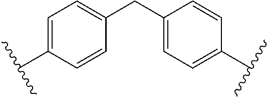 [SMILES: *c1ccc(Cc2ccc(*)cc2)cc1] |
| p-phenylene diisocyanate (PDI) | 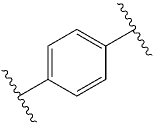 [SMILES: *c1ccc(*)cc1] |
| Alkyl diisocyanates | —(CH2)_{q}— where q is 2 to 12, preferably 6 |

Representative alcohols that may be reacted with (thio)isocyanate compounds to form soft block segments and hard block segments of the present reinforcing agents include polyether polyols such as polypropylene glycol)[PPG], poly(ethylene glycol)[PEG], poly(tetramethylene glycol) [PTMG] and poly(1,2-butylene glycol) and co-polyether polyols of these; polycarbonate polyols, polyester polyols and hydrocarbon polyols (such as hydrogenated poly(butadiene) polyols), amine-capped derivative of these and combinations thereof. For many optical fiber coating applications, polyether polyols are preferred, with PPG being most preferred. It is preferred to use a non-crystallizing polyol such as PPG. The number average molecular weight of the polyol may be greater than 250 g/mol, or greater than 400 g/mol, or greater than 1000 g/mol, or greater than 2000 g/mol, or greater than 4000 g/mol, or in the range from about 250 g/mol to about 9000 g/mol, or in the range from about 500 g/mol to about 7000 g/mol, or in the range from about 750 g/mol to about 5000 g/mol, or in the range from about 1000 g/mol to about 4000 g/mol.

Linking groups that may be used in diol (or polyfunctional alcohol) or diamine (or polyfunctional amine) reactants for forming hard block segments and soft block segments include alkylene groups and oxygenated alkylene groups.

In one embodiment, the reinforcing agent includes soft block segments with the structure shown in representation (V) or (IX) and hard block segments with the structure shown in representation (V′) or (IX′), where the linking groups R₁ and R₃ are linking groups selected from Table 1, the linking group R₂ is a polyol, and the linking group R₄ is an alkylene group. In a first variation of this embodiment, the polyol R₂ is a sequence of multiple methoxy, ethoxy, propoxy, or butoxy groups and has a number average molecular weight in the range from 250 g/mol to 9000 g/mol, or in the range from 500 g/mol to 7000 g/mol, or in the range from 750 g/mol to 5000 g/mol, or in the range from 1000 g/mol to 4000 g/mol. In a second variation of this embodiment, the linking group R₄ is an alkylene group with 12 or fewer carbon atoms, or 10 or fewer carbon atoms, or 8 or fewer carbon atoms, or 6 or fewer carbon atoms, or 4 or fewer carbon atoms. In a third variation of this embodiment, the linking groups R₁ and R₃ are the same. In a fourth variation of this embodiment, the proportion m/(m+n) of hard block segments is such that m/(m+n)≧0.35, m/(m+n)≧0.40, m/(m+n)≧0.45, or m/(m+n)≧0.50, or m/(m+n)≧0.55, or m/(m+n)≧0.60, or m/(m+n)≧0.65 or m/(m+n) is in the range from 0.35 to 0.75, or in the range from 0.40 to 0.70, or in the range from 0.45 to 0.65. In a fifth variation of the embodiment, the number average molecular weight of the reinforcing agent is greater than 5000 g/mol, or greater than 7500 g/mol, or greater than 10000 g/mol, or greater than 12500 g/mol, or greater than 15000 g/mol, or greater than 17500 g/mol, or greater than 20000 g/mol, or between 5000 g/mol and 25000 g/mol, or between 5000 g/mol and 20000 g/mol, or between 5000 g/mol and 15000 g/mol, or between 10000 g/mol and 20000 g/mol, or between 1000 g/mol and 20000 g/mol, or between 2000 g/mol and 19000 g/mol, or between 3000 g/mol and 18000 g/mol. Further embodiments include reinforcing agents with structures combining two or more of the first, second, third, fourth, and fifth variations of this embodiment.

Terminal (thio)isocyanate groups can be optionally capped through a reaction with any compound capable of reacting with (thio)isocyanate groups that acts to terminate chain growth. Terminal (thio)isocyanate groups can, for example, be capped through reactions with monofunctional alcohols or monofunctional amines. Suitable monofunctional alcohols or monofunctional amines include alkyl alcohols and alkyl amines. Similarly, terminal alcohol groups and terminal amine groups can be capped through reactions with monofunctional (thio)isocyanate compounds. Exemplary (thio)isocyanate reactants that can serve as non-reactive capping agents include, without limitation, methyl isocyanate, ethyl isocyanate, n-propyl isocyanate, i-propyl isocyanate, n-butyl isocyanate, i-butyl isocyanate, n-pentyl isocyanate, n-hexyl isocyanate, n-undecylisocyanate, chloromethyl isocyanate, β-chloroethyl isocyanate, γ-chloropropyl isocyanate, ethoxycarbonylmethyl isocyanate, β-ethoxyethyl isocyanate, α-ethoxyethyl isocyanate, α-butoxyethyl isocyanate, α-phenoxyethylisocyanate, cyclopentyl isocyanate, cyclohexyl isocyanate, methyl isothiocyanate, and ethyl isothiocyanate. Other reaction schemes suitable for capping terminal isocyanate, alcohol, and amine groups are known in the art.

The reinforcing agent is non-reactive, non-radiation curable and improves the strength of cured coatings when included as a component in a radiation-curable coating composition. The reinforcing agent includes urethane and/or urea groups to promote hydrogen bonding with the cured polymer network formed from other components of the coating compositions and have a sufficient number or molecular length of block unit(s) to promote physical entanglements with the cured polymer network formed from other components of the coating composition.

The reinforcing agent can be prepared using standard reactions between isocyanate groups and hydroxyl (alcohol) groups (to form urethane linkages) or amine groups (to form urea linkages) that are well known to those skilled in the art. By way of example, molar measures of the desired reactants can be mixed together in a reaction vessel, with stirring, and maintained at a suitable temperature of about 45° C. to about 80° C., preferably about 70° C., for a duration suitable to allow each step of the reaction to complete. Typically, 30 to 90 minutes is sufficient in this regard depending upon the reaction temperature. The identity and quantity of materials used and the order of addition required to prepare a reinforcing having a given structure would be known to one skilled in the art. In order to facilitate handling of the reinforcing agents during synthesis, especially those with high viscosity, one or more of the radiation curable diluents used in the final formulation, such as, for example, Sartomer SR504 (ethoxylated (4) nonyl phenol acrylate) or IBOA (isobornyl acrylate), can be used as a non-reactive diluent during the synthesis of the reinforcing agent. Illustrative examples describing the synthesis of representative reinforcing agents are given below.

In one embodiment, the reinforcing agent is prepared from a reaction of a diisocyanate compound and a first diol compound in a first reaction under conditions in which the diisocyanate compound is present in excess. In this embodiment, a block segment forms having a urethane linkage in the block unit is formed and the terminal groups of the block segment are primarily or almost exclusively isocyanate groups. If the excess of diisocyanate is sufficiently high, preferential formation of block segments having a single block unit occurs. Upon depletion of the first diol compound, the block segment may be further reacted with a second diol compound. The second diol compound reacts with terminal isocyanate groups to form a product which reacts with a portion of the excess diisocyanate compound to extend the block segment. The first diol may include a linkage between alcohol groups of the type indicated hereinabove as preferable for soft block formation and the second diol may include a linkage between alcohol groups of the type indicated hereinabove as preferable for hard block formation (or vice versa).

In another embodiment, the reinforcing agent is formed from a reaction of one or more diisocyanate compounds and one or more diol compounds in the presence of a radiation-curable component. The radiation-curable component provides a medium for reaction and may act as a solvent or viscosity-control agent. The radiation-curable component may be an ethylenically unsaturated monomer diluent such as the monofunctional and multifunctional ethylenically unsaturated monomer diluents described hereinabove.

Once synthesis of the reinforcing agent is complete, it can be combined with radiation-curable compounds and other components to formulate a coating composition in accordance with the present description. The reinforcing agent is present in the coating composition in an amount in the range from about 5 wt % to about 35 wt %, or in the range from about 10 wt % to about 30 wt %, or in the range from about 10 wt % to about 20 wt %.

In certain embodiments, the primary coating composition includes about 1 wt % to about 20 wt % of one or more curable crosslinkers, about 10 wt % to about 60 wt % percent of one or more curable diluents, and about 15 wt % to about 40 wt % of one or more of the present reinforcing agents. In a variation of this embodiment, each of the one or more curable crosslinkers may have a number average molecular weight less than 2000 g/mol, or less than 1000 g/mol, or less than 500 g/mol and/or the number average molecular weight of the reinforcing agent may be less than about 30000 g/mol, or less than 25000 g/mol, or less than 20000 g/mol, or less than 15000 g/mol.

In another embodiment, the primary coating composition includes about 2 wt % to about 15 wt % of one or more curable crosslinkers, about 4 wt % to about 50 wt % of one or more curable diluents, and about 15 wt % to about 40 wt % of one or more of the present reinforcing agents. In a variation of this embodiment, each of the one or more curable crosslinkers may have a number average molecular weight less than 2000 g/mol, or less than 1000 g/mol, or less than 500 g/mol and/or the number average molecular weight of the reinforcing agent may be less than about 30000 g/mol, or less than 25000 g/mol, or less than 20000 g/mol, or less than 15000 g/mol.

In another embodiment, the primary coating composition includes about 3 wt % to 10 wt % of one or more curable crosslinkers, about 25 wt % to about 50 wt % of one or more curable diluents, and about 15 wt % to about 40 wt % of one or more of the present reinforcing agents. In a variation of this embodiment, each of the one or more curable crosslinkers may have a number average molecular weight less than 2000 g/mol, or less than 1000 g/mol, or less than 500 g/mol and/or the number average molecular weight of the reinforcing agent may be less than about 30000 g/mol, or less than 25000 g/mol, or less than 20000 g/mol, or less than 15000 g/mol.

In a further embodiment, the primary coating composition includes about 1 wt % to about 20 wt % of one or more curable crosslinkers, about 60 wt % to about 85 wt % of one or more curable diluents, and about 5 wt % to about 25 wt % of one or more of the present reinforcing agents. In a variation of this embodiment, each of the one or more curable crosslinkers may have a number average molecular weight less than 2000 g/mol, or less than 1000 g/mol, or less than 500 g/mol and/or the number average molecular weight of the reinforcing agent may be less than about 30000 g/mol, or less than 25000 g/mol, or less than 20000 g/mol, or less than 15000 g/mol.

The base primary coating composition includes a polymerization initiator. The polymerization initiator is a reagent that is suitable to cause polymerization (i.e., curing) of the composition after its application to a glass fiber. Polymerization initiators suitable for use in the primary coating compositions include thermal initiators, chemical initiators, electron beam initiators, and photoinitiators. Photoinitiators are the preferred polymerization initiators. For most acrylate-based coating formulations, conventional photoinitiators, such as the known ketonic photoinitiators and/or phosphine oxide photoinitiators, are preferred. When used in the present coating compositions, the photoinitiator is present in an amount sufficient to provide rapid ultraviolet curing. Generally, this includes between about 0.5 to about 10.0 percent by weight, more preferably between about 1.5 to about 7.5 percent by weight.

The photoinitiator, when used in a small but effective amount to promote radiation cure, should provide reasonable cure speed without causing premature gelation of the coating composition. A desirable cure speed is any speed sufficient to cause substantial curing of the coating materials.

Suitable photoinitiators include, without limitation, 1-hydroxycyclohexylphenyl ketone (e.g. Irgacure 184 available from BASF), (2,6-dimethoxybenzoyl)-2,4,4-trimethylpentyl phosphine oxide (e.g. commercial blends Irgacure 1800, 1850, and 1700 available from BASF), 2,2-dimethoxyl-2-phenyl acetophenone (e.g. Irgacure 651, available from BASF), bis(2,4,6-trimethyl benzoyl)phenyl-phosphine oxide (e.g. Irgacure 819, available from BASF), (2,4,6-trimethylbenzoyl)diphenyl phosphine oxide (e.g. Lucerin TPO available from BASF, Munich, Germany), ethoxy(2,4,6-trimethylbenzoyl)phenyl phosphine oxide (e.g. Lucerin TPO-L from BASF), and combinations thereof.

In addition to the base components (curable crosslinker, curable diluent, reinforcing agent, and polymerization initiator), the present primary coating compositions may also include one or more additives. Representative additives include an adhesion promoter, an antioxidant, a catalyst, a carrier or surfactant, a tackifier, a stabilizer, and an optical brightener. Some additives (e.g., catalysts, reactive surfactants, and optical brighteners) may operate to control the polymerization process and may thereby affect the physical properties (e.g., modulus, glass transition temperature) of the cured product formed from the coating composition. Other additives may influence the integrity of the cured product of the coating composition (e.g., protect against de-polymerization or oxidative degradation).

As is well known in the art, an adhesion promoter enhances the adhesion of the primary coating to the underlying glass fiber. Any suitable adhesion promoter can be employed. Examples of a suitable adhesion promoter include, without limitation, organofunctional silanes, titanates, zirconates, and mixtures thereof. One preferred class are the poly(alkoxy)silanes. Suitable alternative adhesion promoters include, without limitation, bis(trimethoxysilylethyl)benzene, 3-mercaptopropyltrimethoxysilane (3-MPTMS, available from United Chemical Technologies, Bristol, Pa.; also available from Gelest, Morrisville, Pa.), 3-acryloxypropyltrimethoxysilane (available from Gelest), and 3-methacryloxypropyltrimethoxysilane (available from Gelest), and bis(trimethoxysilylethyl)benzene (available from Gelest). Other suitable adhesion promoters are described in U.S. Pat. Nos. 4,921,880 and 5,188,864 to Lee et al., each of which is hereby incorporated by reference. The adhesion promoter, if present, is used in an amount between about 0.1 to about 10 pph, more preferably about 0.25 to about 3 pph.

Any suitable antioxidant can be employed. Preferred antioxidants include, without limitation, bis hindered phenolic sulfide or thiodiethylene bis(3,5-di-tert-butyl)-4-hydroxyhydrocinnamate (e.g. Irganox 1035, available from BASF), 2,6-di-t-butyl-4-methylphenol (BHT). The antioxidant, if present, is used in an amount between about 0.1 to about 3 pph, more preferably about 0.25 to about 2 pph.

An exemplary catalyst is a tin catalyst, such as dibutyltin dilaurate, which is used to catalyze the formation of urethane bonds in some non-radiation curable components. Whether the catalyst remains as an additive of the non-radiation curable component or additional quantities of the catalyst are introduced into the composition, the presence of the catalyst may act to stabilize the non-radiation curable component(s) in the composition. Any tendency of excess tin catalyst to destabilize the silane adhesion promoter can be counteracted by addition of tetrathiol.

Suitable carriers, more specifically carriers which function as reactive surfactants, include polyalkoxypolysiloxanes. Exemplary preferred carriers are available from Goldschmidt Chemical Co. (Hopewell, Va.) under the tradename TEGORAD 2200 and TEGORAD 2700 (acrylated siloxane). These reactive surfactants may be present in a preferred amount between about 0.01 pph to about 5 pph, more preferably about 0.25 pph to about 3 pph. Other classes of suitable carriers are polyols and non-reactive surfactants. Examples of suitable polyols and non-reactive surfactants include, without limitation, the polyol Acclaim 3201 (poly(ethylene oxide-co-propylene oxide)) available from Bayer (Newtown Square, Pa.), and the non-reactive surfactant Tegoglide 435 (polyalkoxy-polysiloxane) available from Goldschmidt Chemical Co. The polyol or non-reactive surfactants may be present in a preferred amount between about 0.01 pph to about 10 pph, more preferably about 0.05 pph to about 5 pph, most preferably about 0.1 pph to about 2.5 pph.

Suitable carriers may also be ambiphilic molecules. An ambiphilic molecule is a molecule that has both hydrophilic and hydrophobic segments. The hydrophobic segment may alternatively be described as a lipophilic (fat/oil loving) segment. A tackifier is an example of one such ambiphilic molecule. A tackifier is a molecule that can modify the time-sensitive rheological property of a polymer product. In general a tackifier additive will make a polymer product act stiffer at higher strain rates or shear rates and will make the polymer product softer at low strain rates or shear rates. A tackifier is an additive that is commonly used in the adhesives industry, and is known to enhance the ability of a coating to create a bond with an object that the coating is applied upon. One preferred tackifier is Uni-tac® R-40 (hereinafter “R-40”) available from International Paper Co., Purchase, N.Y. R-40 is a tall oil rosin, which contains a polyether segment, and is from the chemical family of abietic esters. A suitable alternative tackifier is the Escorez series of hydrocarbon tackifiers available from Exxon. For additional information regarding Escorez tackifiers, see U.S. Pat. No. 5,242,963 to Mao, which is hereby incorporated by reference in its entirety. The aforementioned carriers may also be used in combination. Preferably, the tackifier is present in the composition in an amount between about 0.01 pph to about 10 pph, more preferably in the amount between about 0.05 pph to about 5 pph.

Any suitable stabilizer can be employed. One preferred stabilizer is a tetrafunctional thiol, e.g., pentaerythritol tetrakis(3-mercaptopropionate) from Sigma-Aldrich (St. Louis, Mo.). The stabilizer, if present, is used in an amount between about 0.01 pph to about 1 pph, more preferably about 0.01 pph to about 0.2 pph.

Any suitable optical brightener can be employed. Exemplary optical brighteners include, without limitation, Uvitex OB, a 2,5-thiophenediylbis(5-tert-butyl-1,3-benzoxazole) (BASF); Blankophor KLA, available from Bayer; bisbenzoxazole compounds; phenylcoumarin compounds; and bis(styryl)biphenyl compounds. The optical brightener is desirably present in the composition at a concentration of about 0.003 pph to about 0.5 pph, more preferably about 0.005 pph to about 0.3 pph.

Representative primary coating compositions are described in the Examples presented hereinbelow.

The secondary coating 26 of the optical fiber shown in FIG. 1 is typically the polymerization product of a coating composition that contains urethane acrylate liquids whose molecules become highly crosslinked when polymerized. The Young's modulus of the secondary coating is reported herein for secondary coating compositions configured as cured rods according to the following description: Rods were prepared by injecting samples of the curable secondary composition into Teflon® tubing having an inner diameter of about 0.022″. The samples were cured using a Fusion D bulb at a dose of about 2.4 J/cm² (measured over a wavelength range of 225-424 nm by a Light Bug model IL390 from International Light). After curing, the Teflon® tubing was stripped away. The cured rods were allowed to condition overnight at 23° C. and 50% relative humidity. After curing the rod diameter was about 0.022″. Properties such as Young's modulus, tensile strength, and % elongation at break for the cured rods formed from the secondary composition were measured using a tensile testing instrument (e.g., a Sintech MTS Tensile Tester, or an Instron Universal Material Test System) on the cured secondary rod samples. The gauge length of the testing instrument was 51 mm, and the test speed was 250 mm/min. Properties were determined as an average of five samples, with outlying data points and obviously defective rod samples being excluded from the average.

The secondary coating 26 has a Young's modulus, when configured as a cured rod having a diameter of about 0.022″ of at least about 1200 MPa, or at least about 1300 MPa, or at least about 1400 MPa, or at least about 1500 MPa, or at least about 1600 MPa, or at least about 1700 MPa, or at least about 1800 MPa. The cured polymeric material of secondary coating 26, when configured as a cured rod having a diameter of about 0.022″, has an elongation to break of at least about 30%, preferably at least about 40%. The cured polymeric material of secondary coating 26, when configured as a cured rod having a diameter of about 0.022″, has an average tensile strength of at least about 45 MPa, more preferably at least about 50 or 55 MPa, most preferably at least about 60 MPa. The T_{g} of the secondary coating, when configured as a cured rod having a diameter of about 0.022″, is preferably between about 50° C. and about 120° C., more preferably between about 50° C. and about 100° C. The secondary coating 26 typically has a thickness of about 20 to about 35 μm, preferably about 25 to about 27 μm.

Other suitable materials for use in secondary coatings, as well as considerations related to selection of these materials, are well known in the art and are described in U.S. Pat. Nos. 4,962,992 and 5,104,433 to Chapin, each of which is hereby incorporated by reference in its entirety.

The secondary coatings are typically applied to the previously coated fiber (either with or without prior curing) and subsequently cured, as will be described in more detail herein below. Various additives that enhance one or more properties of the coating can also be present, including antioxidants, catalysts, lubricants, low molecular weight non-crosslinking resins, stabilizers, surfactants, surface agents, slip additives, waxes, micronized-polytetrafluoroethylene, etc. The secondary coating may also include an ink, as is well known in the art.

Another aspect of the exemplary embodiments relates to a method of making an optical fiber including the primary coating described herein. This method can generally be performed by standard methods with the use of a composition in accordance with the present description. Briefly, the process involves fabricating the glass fiber (using methods familiar to the skilled artisan), applying a primary coating composition to the glass fiber, polymerizing (curing) the primary coating composition to form the primary coating material, applying a secondary coating composition to the primary coating composition, and polymerizing (curing) the curable secondary composition to form the secondary coating of the optical fiber. This is known as a “wet-on-dry” process since the primary coating composition is cured to form a solid coating before the liquid secondary coating composition is applied. Optionally, the secondary coating composition can be applied to the fiber after application of the primary coating composition and before curing the primary coating composition. In this process, which is known as a “wet-on-wet” process, only a single polymerization (curing) step is employed to form solid coatings from the primary and secondary coating compositions.

The primary and secondary coating compositions are coated on a glass fiber using conventional processes, for example, on a draw tower. It is well known to draw glass fibers from a specially prepared, cylindrical preform which has been locally and symmetrically heated to a temperature, e.g., of about 2000° C. As the preform is heated, such as by feeding the preform into and through a furnace, a glass fiber is drawn from the molten material. One or more coating compositions are applied to the glass fiber after it has been drawn from the preform, preferably immediately after cooling. The coating compositions are then cured to produce the coated optical fiber. The method of curing can be thermal, chemical, or radiation induced, such as by exposing the applied (uncured) coating composition on the glass fiber to ultraviolet light, actinic radiation, microwave radiation, or electron beam, depending upon the nature of the coating composition(s) and polymerization initiator being employed. One method of applying dual layers of coating compositions to a moving glass fiber is disclosed in U.S. Pat. No. 4,474,830 to Taylor, which is hereby incorporated by reference in its entirety. Another method for applying dual layers of coating compositions onto a glass fiber is disclosed in U.S. Pat. No. 4,581,165 to Rannell et al., which is hereby incorporated by reference in its entirety.

Referring now to FIG. 2, another aspect of the exemplary embodiments relates to an optical fiber ribbon 30. The ribbon 30 includes a plurality of optical fibers 20 and a matrix 32 encapsulating the plurality of optical fibers. Optical fibers 20 include a core glass region, a cladding glass region, a primary coating in accordance with the present disclosure, and a secondary coating. The optical fibers 20 are substantially aligned relative to one another in a substantially planar relationship. It is desirable that optical fibers 20 are not displaced from a common plane by a distance of more than about one-half the diameter thereof. By “substantially aligned”, it is intended that the optical fibers 20 are generally parallel with other optical fibers along the length of the fiber optic ribbon 30. The optical fibers in fiber optic ribbons may be encapsulated by the matrix 32 in any known configuration (e.g., edge-bonded ribbon, thin-encapsulated ribbon, thick-encapsulated ribbon, or multi-layer ribbon) by conventional methods of making fiber optic ribbons. In FIG. 2, the fiber optic ribbon 30 contains twelve (12) optical fibers 20; however, it should be apparent to those skilled in the art that any number of optical fibers 20 (e.g., two or more) may be employed to form fiber optic ribbon 30 disposed for a particular use.

The matrix 32 can be any suitable secondary coating composition, such those as described above. The matrix 32 can be formed from the same composition used to prepare the secondary coating 26, or the matrix 32 can be formed from a different composition that is otherwise compatible for use. The skilled artisan will appreciate that the optical fibers 20 may include a dual-layer coating system (for example, the primary and secondary coatings described hereinabove), and may be colored with a marking ink.

The fiber optic ribbon 30 may be prepared by conventional methods using an optical fiber containing a primary coating of the type described herein. For example, upon alignment of a plurality of substantially planar optical fibers having primary coatings in accordance with the exemplary embodiments described herein, the matrix composition can be applied and cured according to the methods of preparing optical fiber ribbons as described in U.S. Pat. No. 4,752,112 to Mayr and U.S. Pat. No. 5,486,378 to Oestreich et al., which are hereby incorporated by reference in their entirety.

### EXAMPLES

The following Examples are intended to illustrate exemplary embodiments and are not intended to be limiting.

The representative reinforcing agents described in the following Examples have hard block segments and soft block segments of the type shown in representation (V). In the soft block segments, the linking group R₁ is derived from H12MDI and corresponds to the 4,4′-methylene bis(cyclohexyl) group. The linking group R₂ of the soft block segments is derived from polypropylene glycol and has the form —R′—(OR′)ₓ—, where —(OR′)ₓ— is a polyol group and R′ is a propylene group (—CH₂—CH(CH₃)—). In the hard block segments, the linking group R₁ is derived from H12MDI and corresponds to the 4,4′-methylene bis(cyclohexyl) group and the linking group R₂ is derived from 1,4-butanediol and has the form —(CH₂)₄—. As noted below, reinforcing agents were prepared using various molecular weights of polypropylene glycol. The soft segment portion of the exemplary reinforcing agents were formed through reaction of 4,4′-methylene bis(cyclohexyl)diisocyanate (H12MDI) with polypropylene glycol and the hard segment portion of the exemplary reinforcing were formed through reaction of 4,4′-methylene bis(cyclohexyl) diisocyanate (H12MDI) with 1,4-butanediol. The amounts of the reactants were varied to provide reinforcing agents with different molar proportions of hard block segments and soft block segments. Under the reaction conditions of the present Examples, the reinforcing agents are expected to have a random arrangement of hard block segments and soft block segments. Bonds between soft block segments and hard block segments are of the type shown in representation (VII) above. In the reaction conditions of the present Examples, H12MDI is present in excess relative to the amount of poly(propylene glycol) during formation of the soft block segment and the reactions are performed in the presence of a monofunctional radiation-curable monomer diluent.

Representative Small Scale Preparation of a Non-Reactive, Non-Radiation-Curable Urethane Reinforcing Agent with Hard/Soft Block Ratio of 0.6/0.4

26.2 g (0.11 mol) 4,4′-methylene bis(cyclohexyl)diisocyanate (H12MDI); 51 mg 2,6-di-t-butyl-4-methylphenol (an antioxidant); 71 mg dibutyltin dilaurate (a catalyst); and 79 g ethoxylated (4) nonylphenol acrylate (SR504) (monomer diluent) were placed in a 500 mL resin kettle equipped with a mechanical stirrer, a CaCl₂ drying tube, a thermometer and an addition funnel. 50 g (0.04 mol) poly(propylene glycol) having an Mₙ of 1250 (based on reported hydroxyl number of 89.3) was added dropwise to the resin kettle. The reaction temperature was kept below 30° C. during the addition. The addition funnel was flushed with 3 g SR504 after the addition was complete. The mixture was heated at approximately 70-75° C. for 1 h, and then cooled to an internal temperature of about 65° C. 5.40 g (0.06 mol) of 1,4-butanediol was then added dropwise over a time period of approximately 5 min, followed by 3 g of SR504 to flush the addition funnel. The mixture was again heated at approximately 70° C. for 2.5 hr, at which point FTIR analysis of an aliquot of the reaction product confirmed the absence of residual isocyanate. The reaction product included ˜50 wt % of reinforcing agent in SR504.

Representative Large Scale Preparation of a Non-Reactive, Non-Radiation-Curable Urethane Reinforcing Agent with Hard/Soft Block Ratio of 0.6/0.4

562 g (2.14 mol) 4,4′-methylene bis(cyclohexyl)diisocyanate (H12MDI); 2.2 g 2,6-di-t-butyl-4-methylphenol (an antioxidant); 1.1 g dibutyltin dilaurate (a catalyst) and 1650 g ethoxylated (4) nonylphenol acrylate (SR504) were placed in a 10 L jacketed reaction vessel. 1072 g (0.86 mol) of poly(propylene glycol) having an Mₙ of 1250 (based on reported hydroxyl number of 89.3) was added dropwise to the mixture over a time period of approximately 40 min. The reaction temperature was kept below 30° C. during the addition of the poly(propylene glycol). When the addition of poly(propylene glycol) was complete, residue in the addition funnel was flushed into the reactor with 50 g of SR504. The mixture was heated at approximately 70° C. and held at this temperature for 1.5 hr. The internal temperature was reduced to approximately 60-65° C., and 115.8 g (1.29 mol) of 1,4-butanediol was added over about 40 min, keeping the reaction temperature below 70° C. during the addition. When the addition of 1,4-butanediol was complete, 50 g of SR504 was added to flush the addition funnel. The mixture was again heated at approximately 70° C. for 2.5 hr, at which point FTIR analysis of an aliquot of the reaction product confirmed the absence of residual isocyanate. Approximately 3400 g of reaction product was isolated (˜98% mass recovery). The reaction product included ˜50 wt % of reinforcing agent in SR504.

### Molecular Weight Determination

The number average (Mₙ) and weight average (M_{w}) molecular weight of several reinforcing agents prepared by the small scale and large scale techniques were determined by GPC (gel permeation chromatography). The samples of each reinforcing agent (in the form of the as-recovered reaction product—˜50 wt % reinforcing agent in SR504) were diluted using a tetrahydrofuran+0.05% toluene solution to a concentration of ˜5000 μg/g. The toluene was used as a flow rate marker to ensure the GPC system was consistent throughout the entire analysis. The GPC instrument used was a Waters Alliance 2695 with Millennium software. The mobile phase was tetrahydrofuran and the column set that included used a series of three columns (manufactured by Polymer Labs): 2 columns: PLgel Mixed D (PLgel is a polystyrene-divinyl benzene copolymer), 5 μm (particle size), 300 mm×7.5 mm (column dimensions) and 1 column: PLgel (PLgel is a polystyrene-divinyl benzene copolymer), 100 Å pore size, 5 μm (particle size), 300 mm×7.5 mm (column dimensions). The column set was optimum for the molecular weight range of interest. The columns were calibrated using polystyrene standards ranging from 160 g/mol-6,980,000 g/mol using EasiCal PS-1&2 kits. The instrument parameters included using a flow rate of 1.0 ml/min with a column temperature of 40° C. The injection volume was 100 μl using a 100 μL sample loop with a run time of 35 minutes at isocratic conditions. The detector was a Waters Alliance 2410 differential refractometer operated at 40° C. and sensitivity level 4. The samples were injected twice along with a THF+0.05% toluene blank.

Table I lists samples prepared using the small scale procedure described above and Table II lists samples prepared using the large scale procedure described above. Each sample corresponds to 50 wt % reinforcing agent in SR504. The column labeled “MW (PPG)” indicates the number average molecular weight of polypropylene glycol) used in the preparation. The column labeled “ID” is a sample identification number. The columns labeled “M_{w}”, “Mₙ”, and “M_{w}/Mₙ” list weight average molecular weight, number average molecular weight, and their ratio, respectively, of the reinforcing agent. The columns labeled “n/(n+m)” and “m/(n+m)” list the molar proportions (mole fractions) of soft block segments and hard block segments, respectively, in the reinforcing agent. The columns labeled “Wt % (soft)” and “Wt % (hard)” list the proportions of soft block segments and hard block segments, respectively, in the reinforcing agent on a weight basis.

TABLE I
Representative Reinforcing Agents (Small Scale Preparation)

| MW | | | | | n | m | Wt. % | Wt. % |
|---|---|---|---|---|---|---|---|---|
| (PPG) | ID | M_{w} | Mₙ | M_{w}/Mₙ | n̅ +̅ m̅ | n̅ +̅ m̅ | (soft) | (hard) |
| 1250 | DNS67 | 20800 | 13400 | 1.55 | 0.4 | 0.6 | 73 | 27 |
| 1250 | DNS71 | 16800 | 11400 | 1.47 | 0.6 | 0.4 | 86 | 14 |
| 1250 | DNS72 | 17700 | 12000 | 1.48 | 0.5 | 0.5 | 80 | 20 |
| 4000 | DNS75 | 21500 | 13000 | 1.64 | 0.2 | 0.8 | 75 | 25 |
| 4000 | DNS76 | 23000 | 16100 | 1.42 | 0.4 | 0.6 | 89 | 11 |
| 4000 | DNS78 | 22000 | 14600 | 1.51 | 0.3 | 0.7 | 84 | 16 |
| 2000 | DNS77 | 24300 | 16100 | 1.51 | 0.4 | 0.6 | 81 | 19 |

TABLE II
Representative Reinforcing Agents (Large Scale Preparation)

| MW | | | | | n | m | Wt. % | Wt. % |
|---|---|---|---|---|---|---|---|---|
| (PPG) | ID | M_{w} | Mₙ | M_{w}/Mₙ | n̅ +̅ m̅ | n̅ +̅ m̅ | (soft) | (hard) |
| 1250 | DNS69 | 33200 | 19800 | 1.68 | 0.4 | 0.6 | 73 | 27 |
| 1250 | DNS70 | 29600 | 18100 | 1.63 | 0.4 | 0.6 | 73 | 27 |
| 1250 | DNS73 | 18600 | 12500 | 1.49 | 0.4 | 0.6 | 73 | 27 |
| 1250 | DNS74 | 19900 | 13200 | 1.50 | 0.4 | 0.6 | 73 | 27 |
| 1250 | DNS79 | 27400 | 16900 | 1.62 | 0.4 | 0.6 | 73 | 27 |
| 1250 | DNS80 | 29000 | 18000 | 1.61 | 0.4 | 0.6 | 73 | 27 |
| 1250 | DNS81 | 30000 | 18500 | 1.62 | 0.4 | 0.6 | 73 | 27 |
| 1250 | DNS84 | 26700 | 16800 | 1.59 | 0.4 | 0.6 | 73 | 27 |
| 1250 | DNS86 | 27600 | 17200 | 1.60 | 0.4 | 0.6 | 73 | 27 |
| 1250 | DNS87 | 26000 | 16300 | 1.59 | 0.4 | 0.6 | 73 | 27 |

### Coatings

Coatings in the form of cured films were prepared from coating compositions containing several of the reinforcing agents listed in Tables I and II. The composition, coating preparation, and properties of the cured films are described in the remarks below.

### Formulations

Coating formulations were prepared by pre-heating the reinforcing agent (supplied in the form of a 50 wt % solution in SR504) at 60° C.-100° C. for 12 hr (to facilitate pouring) and combining the pre-heated reinforcing agent with one or more co-monomers, a photoinitiator, and an antioxidant. The components of the coating formulation were heated in the dark at −60° C. and blended until uniform.

Table III lists the composition of the representative coating formulations tested in this Example. The listed compositions include the reinforcing agents and the monomer(s) used in the formulation. Lucerin TPO ((2,4,6-trimethylbenzoyl)diphenyl phosphine oxide, available from BASF) was used as the photoinitiator in all coating formulations and was included at a concentration of 3 wt %. Irganox 1035 (thiodiethylene bis(3,5-di-tert-butyl)-4-hydroxyhydrocinnamate, available from BASF) was used as the antioxidant in all coating formulations and was included at a concentration of 1 pph.

In Table III, SR504 is ethoxylated(4) nonylphenol acrylate (available from Sartomer Company, Inc.); SR256 is ethoxyethoxyethyl acrylate (available from Sartomer Company, Inc.); SR495 is caprolactone acrylate (available from Sartomer Company, Inc.); SR306 is tripropylene glycol diacrylate (available from Sartomer Company, Inc.); CD9075 is tetraethyxylated lauryl acrylate (available from Sartomer Company, Inc.); M142 is o-phenylphenol ethyl acrylate (available from Miwon Specialty Chemical Co.); M166 is ethoxylated(8) nonylphenol acrylate (available from Miwon Specialty Chemical Co.); and M144 is ethoxylated(4) phenol acrylate (available from Miwon Specialty Chemical Co.). The reinforcing agents are listed according to the sample ID numbers given in Tables I and II.

The concentrations of the base components of the formulations listed in Table III are expressed in terms of wt % and add up to 97 wt %. The photoinitiator constitutes the remaining 3 wt % of each formulation. As noted hereinabove, the antioxidant is not regarded as a base component of the formulation and its concentration is expressed in units of pph (parts per hundred) relative to the base components.

In the formulations listed in Table III, SR504 is included both as an independent diluent and as a component (at 50 wt %) of the reinforcing agent. The total concentration of SR504 in each of the formulations accordingly is the amount listed for SR504 as an independent diluent and half the amount listed for the reinforcing agent. In formulation 155-4, for example, the concentration of SR504 as an independent diluent is 61 wt % and the concentration of reinforcing agent (DNS84) is 28 wt %. The total concentration of SR504 is thus 61 wt %+half of 28 wt %=75 wt %. In formulations that do not include SR504 as an independent diluent, the total concentration of SR504 is half the concentration of the reinforcing agent.

TABLE III
Coating Formulations

| Formulation | Base Components | Wt % |
|---|---|---|
| 137-1 | SR504 | 54 |
| | SR306 | 7 |
| | DNS73/74 | 36 |
| 140-7R | SR504 | 34 |
| | CD9075 | 25 |
| | SR306 | 7 |
| | DNS79/80 | 32 |
| 143-1 | SR504 | 49 |
| | CD9075 | 10 |
| | SR306 | 632 |
| | DNS79/80 | |
| 140-6 | SR504 | 59 |
| | SR306 | 6 |
| | DNS79 | 32 |
| 143-4 | SR504 | 39 |
| | M142 | 22 |
| | SR306 | 6 |
| | DNS79 | 30 |
| 150-1 | SR504 | 35 |
| | M142 | 15 |
| | CD9075 | 10.5 |
| | SR306 | 4.5 |
| | SR495 | 3 |
| | DNS81 | 29 |
| 153-2 | SR504 | 25 |
| | M142 | 35 |
| | SR306 | 4.5 |
| | SR495 | 3.5 |
| | DNS84 | 29 |
| 153-8 | M166 | 25 |
| | M142 | 35 |
| | SR306 | 4.5 |
| | SR495 | 3.5 |
| | DNS84 | 29 |
| 155-4 | SR504 | 61 |
| | SR306 | 5 |
| | SR495 | 3 |
| | DNS84 | 28 |
| 155-5 | SR504 | 55 |
| | SR256 | 5 |
| | SR306 | 5 |
| | SR495 | 3 |
| | DNS84 | 29 |
| 155-9 | M166 | 61 |
| | SR306 | 5 |
| | SR495 | 3 |
| | DNS84 | 28 |
| 156-2 | M166 | 55 |
| | SR256 | 5 |
| | SR306 | 5 |
| | SR495 | 3 |
| | DNS84 | 29 |
| 156-3 | SR504 | 25 |
| | M144 | 35 |
| | SR306 | 5 |
| | SR495 | 3 |
| | DNS84 | 29 |
| P1293 | SR504 | 25 |
| | M144 | 33 |
| | SR306 | 5 |
| | SR495 | 5 |
| | DNS84 | 29 |
| P1295 | M166 | 59 |
| | SR306 | 6 |
| | SR495 | 4 |
| | DNS87 | 28 |

### Cured Film Preparation and Testing

Films were prepared by drawing down the liquid formulations on silicone-treated release paper mounted on a glass plate. The draw down bar provided a liquid coating with a uniform thickness of 5 mil (∫125 μm). Films were prepared by curing the liquid formulations using a Fusion D lamp with a nitrogen purge. The curing dose was approximately 1350 mJ/cm². The cured films were conditioned overnight in a controlled environment at 23° C. and 50% relative humidity. The thickness of the cured films was ˜80 μm.

Tensile properties of the cured films were measured using either a Sintech MTS or Instron tensile tester according to procedures set forth in ASTM Standard D882-97. The cured films were cut to a specified length and width (15 cm×1.3 cm) and mounted in the test instrument. The gauge length used for testing was 5.1 cm and the test speed was 2.5 cm/minute. Tensile strength, stress at yield point (where yielding was significant), % strain at break (% elongation), and Young's Modulus values were determined for the cured films. The glass transition temperature (T_{g}) of the cured films (cut to a length of 10 mm and a width of 10 mm) were determined from the tan δ curves measured on a Seiko-5600 DMS test instrument in tension at a frequency of 1 Hz and ramping temperature at a rate of 1° C./min. Tan δ is defined as the loss modulus (E″) divided by storage modulus (E′). Young's Modulus, Tensile Strength, % Elongation and glass transition temperatures of the cured films are listed in Table IV. The cured films are identified by the formulation number listed in Table III.

TABLE IV
Properties of Cured Films

| | Young's | Tensile | | |
|---|---|---|---|---|
| | Modulus | Strength | Percent | T_{g} |
| Formulation | (MPa) | (MPa) | Elongation | (° C.) |
| 137-1 | 0.68 ± 0.07 | 0.28 ± 0.04 | 52 ± 7 | −12.4 |
| 140-7R | 0.73 ± 0.02 | 0.39 ± 0.04 | 55 ± 5 | −24.4 |
| 143-1 | 0.73 ± 0.06 | 0.37 ± 0.04 | 59 ± 2 | −18.8 |
| 140-6 | 1.17 ± 0.06 | 0.58 ± 0.05 | 57 ± 1 | −12.8 |
| 143-4 | 0.98 ± 0.05 | 0.49 ± 0.04 | 58 ± 5 | −10.7 |
| 150-1 | 0.64 ± 0.05 | 0.35 ± 0.04 | 66 ± 9 | −18.6 |
| 153-2 | 0.55 ± 0.04 | 0.33 ± 0.01 | 68 ± 4 | −18.8 |
| 153-8 | 0.84 ± 0.01 | 0.40 ± 0.03 | 54 ± 3 | −22.9 |
| 155-4 | 0.82 ± 0.05 | 0.37 ± 0.04 | 74 ± 6 | −14.0 |
| 155-5 | 0.76 ± 0.05 | 0.36 ± 0.08 | 73 ± 11 | −17.6 |
| 155-9 | 0.64 ± 0.03 | 0.28 ± 0.02 | 76 ± 3 | −25.8 |
| 156-2 | 0.69 ± 0.06 | 0.32 ± 0.05 | 71 ± 8 | −26.4 |
| 156-3 | 0.88 ± 0.08 | 0.41 ± 0.01 | 71 ± 4 | −18.5 |
| P1293 | 0.70 ± 0.02 | 0.34 ± 0.07 | 75 ± 13 | −17.9 |
| P1295 | 0.75 ± 0.04 | 0.34 ± 0.08 | 70 ± 6 | −25.1 |

The properties exhibited by the cured films are favorable and indicate that coatings formed by curing coating formulations containing the present reinforcing agents are suitable for use as primary coatings for optical fibers.

When configured as a film, coatings formed by curing compositions including a curable component and the present reinforcing agent may have a Young's modulus less than 1.5 MPa, or less than 1.25 MPa, or less than 1.0 MPa, or less than 0.8 MPa, or less than 0.6 MPa.

When configured as a film, coatings formed by curing compositions including a curable component and the present reinforcing agent may have a tensile strength greater than 0.20 MPa, or greater than 0.30 MPa, or greater than 0.40 MPa, or greater than 0.45 MPa, or greater than 0.50 MPa, or greater than 0.55 MPa.

When configured as a film, coatings formed by curing compositions including a curable component and the present reinforcing agent may have a glass transition temperature (T_{g}) less than 0° C., or less than −5° C., or less than −10° C., or less than −15° C., or less than −20° C., or less than −25° C.

It will be apparent to those skilled in the art that numerous modifications and variations can be made to the exemplary embodiments without departing from the intended spirit and scope encompassed by the exemplary embodiments described herein. Thus it is intended that the scope encompassed by the exemplary embodiments covers all modifications and variations that coincide with the scope of the appended claims and their equivalents.

What is claimed is:

1. A coating composition comprising:
(I) a first radiation-curable component;
(II) a non-radiation-curable component, said non-radiation-curable component comprising a non-radiation-curable compound having:
a first block segment, said first block segment including a first block unit, said first block unit having the formula 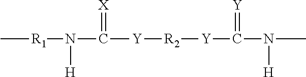
wherein X is O or S, Y is O or N(H); R₁ comprises carbon; and R₂ comprises a polyether polyol group, a polyester polyol group, or a polycarbonate polyol group; and
a second block segment, said second block segment including a second block unit, said second block unit having the formula 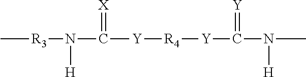
wherein X is O or S, Y is O or N(H), R₃ comprises carbon and R₄ is an alkylene group having 12 or fewer carbon atoms;
wherein said non-radiation-curable compound has a number average molecular weight of at least 5000 g/mol; and
(III) a photoinitiator.

2. The coating composition of claim 1, wherein said first radiation-curable component comprises an ethylenically unsaturated functional group.

3. The coating composition of claim 1, wherein said first radiation-curable component is monofunctional.

4. The coating composition of claim 1, further comprising a second radiation-curable component.

5. The coating composition of claim 4, wherein said first radiation-curable component is monofunctional and said second radiation-curable component is multifunctional.

6. The coating composition of claim 5, wherein said second radiation-curable component has a molecular weight in the range from 200 g/mol to 2000 g/mol and includes two or more ethylenically unsaturated groups.

7. The coating composition of claim 5, wherein said second radiation-curable component lacks urethane and urea groups.

8. The coating composition of claim 5, wherein said first radiation-curable component includes an ethylenically unsaturated group and a polyol group.

9. The coating composition of claim 1, wherein R₁ is an aliphatic group.

10. The coating composition of claim 9, wherein R₁ is the 4,4′-methylene bis(cyclohexyl) group.

11. The coating composition of claim 9, wherein R₃ is the 4,4′-methylene bis(cyclohexyl) group.

12. The coating composition of claim 1, wherein R₂ has the form —R′—(OR′)_{z}—, R′ is an alkylene group, and z is at least 5.

13. The coating composition of claim 1, wherein said non-radiation-curable compound comprises a plurality of said first block segments and a plurality of said second block segments.

14. The coating composition of claim 13, wherein said plurality of said first block segments and said plurality of said second block segments are arranged randomly in the structure of said non-radiation-curable compound.

15. The coating composition of claim 13, wherein said first block segments are present in a first molar proportion in said non-radiation-curable compound and said second block segments are present in a second molar proportion in said non-radiation-curable compound, said second molar proportion being greater than or equal to 0.35.

16. The coating composition of claim 15, wherein said second molar proportion is greater than or equal to 0.45.

17. The coating composition of claim 15, wherein said second molar proportion is greater than or equal to 0.55.

18. The coating composition of claim 1, wherein said non-radiation-curable compound has a number average molecular weight less than 20000 g/mol.

19. The cured product of the coating composition of claim 1.

20. A method comprising reacting a di(thio)isocyanate compound with a first diol compound to form a product, said product including a (thio)urethane linkage and lacking a radiation-curable group, said reacting occurring in the presence of a radiation-curable compound.

21. The method of claim 20, wherein the molar amount of said di(thio)isocyanate compound exceeds the molar amount of said first diol compound.

22. The method of claim 20, wherein said di(thio)isocyanate compound has the formula
X═C═N—R₁—N═C═X
and wherein X is O or S and R₁ is an aliphatic group.

23. The method of claim 20, where said di(thio)isocyanate compound is a compound selected from the group consisting of 4,4′-methylene bis(cyclohexyl)diisocyanate (H12MDI), toluene diisocyanate (TDI), isophorone diisocyanate (IPDI), tetramethyl-1,3-xylylene diisocyanate (XDI), 4,4′-methylene bis(phenyl)diisocyanate (MDI), p-phenylene diisocyanate (PDI).

24. The method of claim 20, wherein said first diol compound has the formula
HO—R₂—OH
and R₂ comprises an alkylene group, an oxyalkylene group, a polyether polyol group, a polycarbonate polyol group, or a polyester polyol group.

25. The method of claim 24, wherein R₂ has the form —R′—(OR′)_{z}—, R′ is an alkylene group, and z is at least 5.

26. The method of claim 20, wherein said radiation-curable compound is a monofunctional acrylate compound.

27. The method of claim 20, further comprising reacting said product with a second diol compound, said second diol compound having the form
HO—R₄—OH
wherein R₄ is an alkylene group.

28. A compound comprising;
a first block segment, said first block segment including a first block unit, said first block unit having the formula 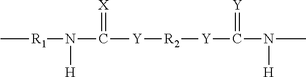
wherein X is O or S, Y is O or N(H), R₁ comprises carbon, R₂ comprises a polyether polyol group, a polyester polyol group, or a polycarbonate polyol group; and
a second block segment, said second block segment including a second block unit, said second block unit having the formula 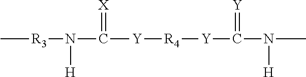
wherein X is O or S, Y is O or N(H), R₃ comprises carbon and R₄ is an alkylene group having 12 or fewer carbon atoms;
wherein said compound lacks a radiation-curable functional group and has a number average molecular weight of at least 5000 g/mol.
